(19) United States
(12) Patent Application Publication
(10) Pub. No.: US 2026/0228052 A1
(43) Pub. Date: Aug. 6, 2026

(54) ARTIFICIAL INTELLIGENCE (AI) CPU PROCESSING WITH SELF-DIRECTED APPLICATION CLUSTER DEPLOYMENTS

(71) Applicant: Intel Corporation, Santa Clara, CA (US)

(72) Inventors: Stephen T. Palermo, Chandler, AZ (US); Bhupesh Agrawal, Hillsboro, OR (US); Shrikant M. Shah, Chandler, AZ (US)

(21) Appl. No.: 19/629,791

(22) Filed: Mar. 26, 2026

Related U.S. Application Data
(60) Provisional application No. 63/959,556, filed on Jan. 13, 2026.

(51) Int. Cl. G06F 9/50; G06F 17/16

(52) U.S. Cl. CPC G06F 9/5044; G06F 17/16

(57) ABSTRACT

Various aspects of configuring and executing artificial intelligence (AI) computing operations on a central processing unit (CPU) with self-directed application deployment at an edge device are described. In an example, an edge computing system improves AI model inferencing within mixed-generation or mixed-capability CPU clusters (e.g., server nodes) by dynamically reassigning tasks based on real-time instruction-usage patterns. High-performance AI nodes can be tagged to ensure deterministic and high-quality inferencing, improving performance on nodes with native AI acceleration capabilities. By binding inference tasks to nodes with AI extensions and distributing other service pods across available nodes, the disclosed approach enhances AI processing throughput while supporting diverse hardware configurations, including CPUs with varying AI inference capabilities (e.g., CPUs that include Advanced Matrix Extensions (AMX) tiles or similar hardware blocks).

### PRIORITY CLAIM

This application claims the benefit of priority to U.S. Provisional Patent Application No. 63/959,556 , filed Jan. 13, 2026, and titled “ARTIFICIAL INTELLIGENCE (AI) CPU PROCESSING WITH SELF-DIRECTED APPLICATION CLUSTER DEPLOYMENTS”, which is incorporated herein by reference in its entirety.

### BACKGROUND

Artificial intelligence (AI) model inferencing operations are being increasingly deployed in a variety of use cases and industries. AI model inferencing may be used in a variety

of settings, such as with edge device visual processing operations that use AI models to analyze

images that are captured from a real-world setting. Current implementations of such AI models and inferencing, however, often require complex and large hardware deployments or specialized

model configurations.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A illustrates a system diagram of an AI-based multi-node server system with tagged nodes and dynamic central processing unit (CPU) reassignment for optimized AI operations, according to an example.

FIG. 1B illustrates a system diagram of an AI-based multi-node server system within a multi-node server chassis, providing dynamic application reassignment based on AI-specific processing capabilities, according to an example.

FIG. 2 illustrates a block diagram of AI CPU chassis configurations showcasing various node types, CPU generations, and AI-CPU capabilities within multi-node server setups, according to an example.

FIG. 3 illustrates a configuration table and CPU core mapping providing AI CPU specifications and application assignments, according to an example.

FIG. 4 illustrates a flowchart of an application deployment technique for a CPU with self-directed reassignment based on real-time AI resource utilization, according to an example.

FIG. 5 illustrates a configuration of a processing device adapted for tracking performance conditions from execution of respective processing workloads among CPU cores, according to an example.

FIG. 6 illustrates a flowchart of a method for allocating processing workloads among CPU cores of a processing device, according to an example.

FIG. 7A provides an overview of example components deployed at an edge device.

FIG. 7B provides a further overview of example components within a computing device.

### DETAILED DESCRIPTION

The following discusses improvements of artificial intelligence (AI) model execution operations, including for addressing technical issues associated with AI computing. Specifically, this disclosure introduces CPU-based AI processing configurations for individual compute nodes or self-directed application cluster deployments, deployable in a variety of environments (e.g., edge computing and cloud computing environments).

AI model inferencing operations are increasingly used for applications such as visual analytics, language models, and other computationally intensive tasks. However, conventional approaches of deploying AI applications on edge nodes and edge clusters face notable limitations. For instance, when AI inference tasks are arbitrarily distributed across nodes without regard to a particular node's capabilities, they may execute on CPUs lacking specialized AI acceleration capabilities, such as Intel® Advanced Matrix Extensions (e.g., matrix acceleration provided by an “AMX” tile, die, or hardware block)). This results in suboptimal performance, including reduced processing rates and AI inferencing throughput.

The following introduces approaches to tag high-performance AI nodes and continuously reassign processing units of nodes (and cores within nodes) for application usage based on real-time instruction-usage patterns. This includes approaches that utilize real-time instruction-usage patterns to identify high-performance AI nodes and CPU cores, and to reallocate inference tasks to processing units equipped with native AI acceleration features inside these nodes or CPU cores. As used herein, a “node” refers to a singular self-contained server unit providing at least some portions of compute, memory, storage, and/or I/O, and in some scenarios, a server unit that participates as a single manageable element in a larger cluster or deployment. A node may be physically configured as a “1U node” that fits in a slim 1U server rack space, a “2U node” that fits in a larger 2U server rack space, or with other configurations.

These approaches facilitate predictable and high-quality inferencing while preserving adaptability to support a range of hardware configurations, including processors with differing AI inference capabilities. For instance, the described examples show how an edge computing deployment can accommodate AI processing using processors with and without matrix multiplication instruction sets (e.g., Intel® Advanced Matrix Extensions (AMX)), allowing effective use of mixed-generation CPU hardware (e.g., Intel® Xeon 4th Generation and Xeon 6 processors), mixed-capability CPUs (e.g., with and without AMX/AI tiles or hardware blocks), mixes of node types (e.g., 1U, 2U, etc.), and mixes of cluster sizes. The described examples also include processes to identify AI-specific mnemonics on CPUs and then reassign workloads (e.g., container pods or applications) involving AI inferencing or training to AI CPU cores within targeted nodes, while repeating the reassignment process iteratively. These approaches work with edge-based (e.g., local cloud, on-premise) air-gapped servers, for a variety of types of deployments that use CPUs to perform AI processing at edge locations. However, as will be apparent, the following techniques are not limited to use of matrix multiplication instructions or matrix multiplication units in hardware, as a variety of other types of operations and instructions may be used in connection with AI processing.

These approaches solve technical issues from deploying an AI app onto a specific node within a group of nodes in a cluster, particularly where each node has different AI performance capabilities. This results in accompanying technical improvements for reduced processing time, increased processor utilization, improved load management, and the like. Further, these approaches help prepare systems to handle the addition or integration of different types of CPUs that may provide different AI inference capabilities (e.g., a node with one or more CPUs that provide some cores with a specialized AI tile or hardware block and other cores without a specialized AI tile or hardware block). The managed use of CPUs with and without specific hardware blocks can understandably maximize yield and minimize scrap during procedures for upgrading and scrapping data center hardware.

The following examples refer to certain configurations of an AI computation unit provided in a hardware block or unit (such as an “AI tile” or “AMX_TILE” provided on a die) but it will be understood that other types of hardware blocks or units may be implemented. Similar types of hardware blocks include units that perform matrix multiplication directly on the CPU core, allowing the CPU to process large chunks of data in a single operation. For example, some types of specialized hardware blocks may perform multiplication on a CPU in stages, such as with the use of tiles or dies that hold sub-arrays of larger matrices (directly on the core instead of fetching data from system memory) and execute multiplication on these tiles or dies, enabling specific functions such as Fused Multiply-Add (FMA) operations.

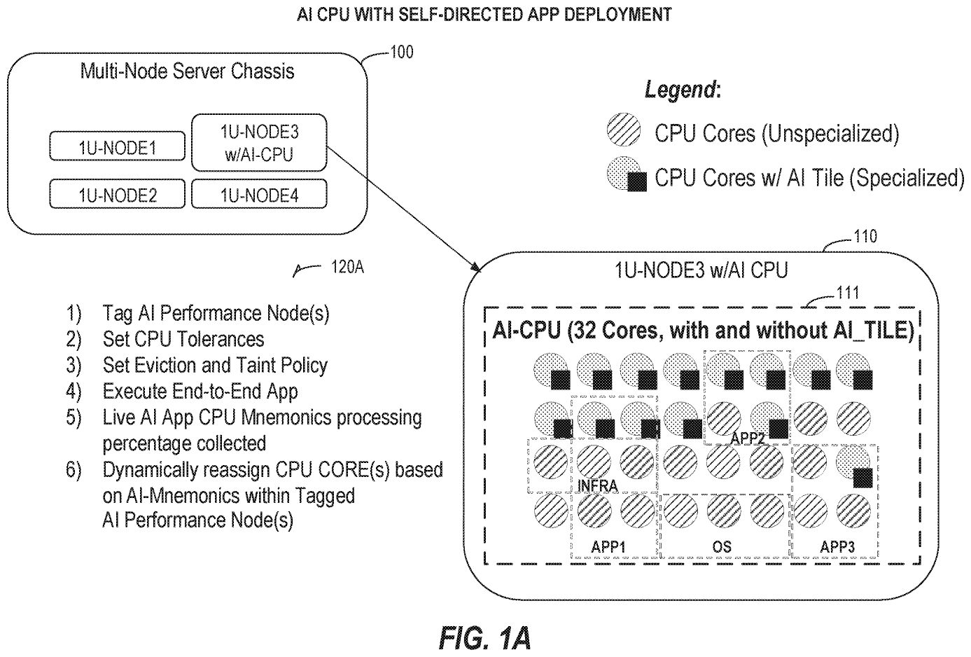

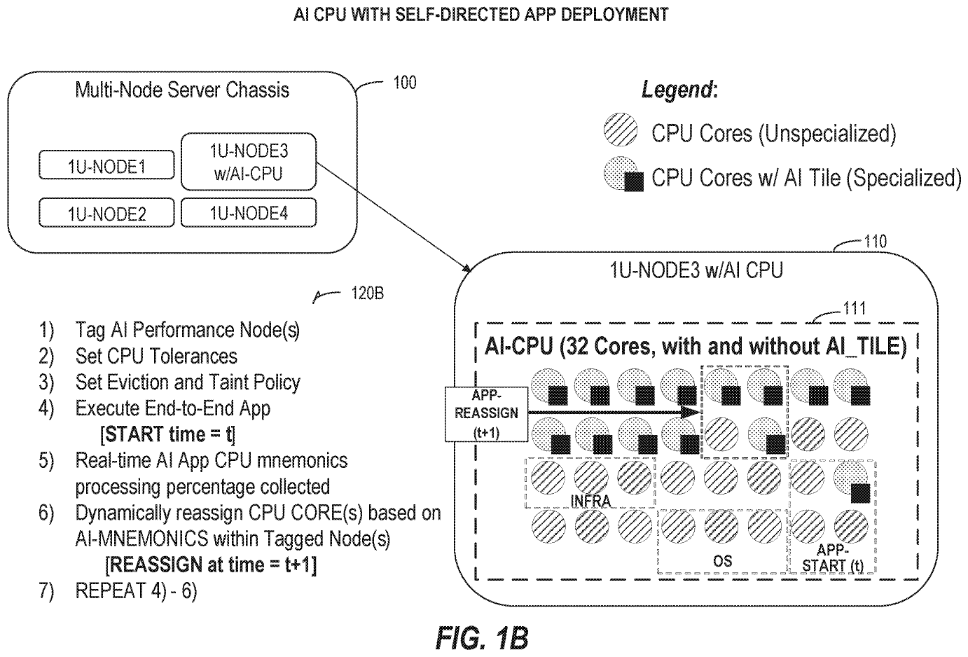

FIG. 1A illustrates a system diagram of an AI-based multi-node server system with tagged nodes and dynamic CPU reassignment for optimized AI operations. The server system is implemented within a multi-node server chassis 100, which houses multiple 1U nodes, including 1U-NODE1, 1U-NODE2, 1U-NODE3 with an AI-CPU, and 1U-NODE4. The AI-CPU 111, located in 1U-NODE3 110, is a 32-core unit with a mix of processing units (e.g., one or multiple CPUs) equipped with and without a specialized AI tile or die (e.g., an AMX tile or die). The AI-CPU 111 may be provided from a single-socket or a multi-socket configuration, and with other arrangements of cores, hardware blocks, nodes, and server-chassis layouts. As will be understood, a CPU (central processing unit) is a processor package that contains all cores and is installed in a socket on a respective compute node. A tile or die is a hardware sub-block within an individual core, such as the AI computation unit (e.g., the AMX_TILE) that provides matrix multiplication acceleration, while a core is one independent processing unit within the CPU. As noted below, each core may or may not contain an AI computation unit (AI tile) depending on processor design, manufacturing yield, and die-level testing outcomes.

The AI-CPU 111, during use, is adapted to execute an end-to-end application (e.g., a containerized application) with various sub-applications (e.g., container pods), including APP1, APP2, and APP3, as well as infrastructure (INFRA) and operating system (OS) processes, shown with respective partitions. The INFRA partition represents infrastructure workloads such as middleware or edge orchestration framework software; OS represents operating system workloads; APP1, APP2, and APP3 represent distinct application workloads. Each partition is shown as occupying a group of cores within the AI-CPU 111, with some partitions allocated to cores that include AI tiles and other partitions allocated to cores that do not include AI tiles.

The AI-CPU 111 includes logic (e.g., executed in the INFRA partition) that is capable of dynamically reallocating processing resources to improve the execution of AI-specific tasks. This is achieved by leveraging real-time monitoring of AI-specific mnemonics processing percentages and reassigning CPU processing units accordingly. The process 120A outlines an example operational flow for self-directed application deployment:
1) Tag AI Performance Node(s): High-performance nodes, such as 1U-NODE3 110 with the AI-CPU 111, are tagged to identify their suitability for executing AI-specific tasks. The use of tags may involve maintaining data structures or a database to track and verify which nodes, CPUs, and/or dies/tiles include the capability for executing these AI-specific tasks.
2) Set CPU Tolerances: CPU tolerances or capabilities are identified and/or verified to ensure that AI applications (e.g., involving specialized inferencing capabilities) are preferentially deployed on nodes with AI acceleration capabilities.
3) Set Eviction and Taint Policy: Policies are established to prevent non-AI workloads from occupying high-performance AI cores.
4) Execute End-to-End App: The various sub-applications including the AI app workloads are executed, and the performance of these AI workloads is monitored in real-time.
5) Live AI App CPU Mnemonics Processing Percentage Collected: Data is collected
that tracks the percentage of AI-specific mnemonics being processed by the various CPU cores.
6) Dynamically Reassign CPU Cores: Based on the collected data, AI workloads are dynamically reassigned, as applicable, to CPU cores with higher AI processing capabilities within the tagged nodes.

FIG. 1B illustrates a variation of this system diagram, providing dynamic application reassignment based on AI-specific processing capabilities. In FIG. 1B, the mapping of an application to a first set of cores (at time (t)) and a second set of cores (at time (t+1)) is shown in the AI-CPU 111. This includes reassigning an application from one set of cores (e.g., that includes only one AI-specialized core) to another set of cores (e.g., that includes more than one, e.g., three AI-specialized cores).

The process 120B outlines this variation of the operational flow for self-directed application deployment. This process 120B includes dynamically reassigning particular CPU cores based on AI-mnemonics being observed within one or more of the CPU cores. As shown, the execution, mnemonic processing, and dynamic reassignment operations can be iteratively repeated for cores and CPUs within the tagged nodes.

Accordingly, this dynamic application reassignment capability supports mixed-generation and mixed-capability CPU clusters, such as a mix of Intel® Xeon Generation 4 and Xeon 6 processors (e.g., single-socket or multi-socket SoCs), enabling efficient utilization of hardware with varying AI inference capabilities. By dynamically reallocating resources, the system ensures high-quality AI inferencing, reduces processing latency, and maximizes throughput, even in edge computing environments with diverse hardware configurations, including in specific server chassis arrangements with a mix of 1U and 2U server sleds.

This dynamic application reassignment capability also supports scenarios where AI app deployment is not deterministic, such as where pod containers for the AI App are randomly distributed among server nodes. In scenarios where the AI App is distributed onto nodes that do not offer maximum AI inference performance, the processes depicted in FIGS. 1A and 1B can be used while redistributing the App deployment to specific cores within specific nodes. For instance, a node can be tagged to ensure the pod that performs an AI inference is bound to an AI-enhanced node, whereas the other service pods of the AI App are allowed to migrate among the other nodes.

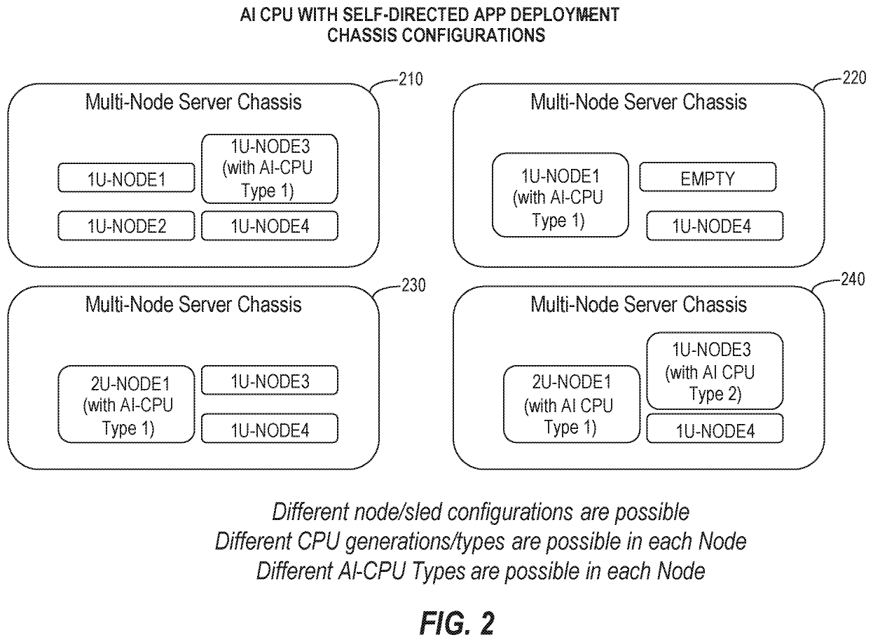

FIG. 2 shows a block diagram illustrating various configurations of AI CPU chassis setups within multi-node server environments. These configurations highlight the flexibility and adaptability of the system to accommodate different node types, different CPU types or generations, and different AI-CPU types and capabilities. Although some of the following configurations refer to the use of Intel® x86-IA processors, it will be understood that other processor types and manufacturers with similar capabilities may be substituted.

The first configuration 210 features a multi-node server chassis with four nodes: 1U-NODE1 without an AI CPU, 1U-NODE2 without an AI CPU, 1U-NODE3 with an AI CPU, and 1U-NODE4 without an AI CPU. The inclusion of a high-performance AI CPU in 1U-NODE3 is optimized for AI-specific tasks such as inferencing. The remaining nodes provide general-purpose compute capabilities, such as for supporting infrastructure and operating system processes.

The second configuration 220 features a multi-node server chassis with two active nodes: 1U-NODE1 with an AI CPU and 1U-NODE4 without an AI CPU, and an EMPTY chassis slot. Here, AI workloads can be optimized by leveraging the AI CPU in 1U-NODE1 with AI CPU while leaving room for future expansion or reconfiguration through use of the EMPTY chassis slot.

The third configuration 230 features a multi-node server chassis with three nodes: 2U-NODE1 (with AI CPU (e.g., Xeon G4)), 1U-NODE3 without an AI CPU, and 1U-NODE4 without an AI CPU. The 2U-NODE1 (with AI CPU (e.g., Xeon G4)) is designed to house a larger, high-performance AI CPU hardware arrangement, such as a Xeon Generation 4 processor, which provides enhanced AI acceleration capabilities. This shows the use of mixed node sizes and the integration of nodes with varying physical dimensions and compute capabilities.

The fourth configuration 240 features a multi-node server chassis with three nodes: 1U-NODE3 with an AI CPU (e.g., Xeon6), 1U-NODE4 without an AI CPU, and 2U-NODE1 with an AI CPU (e.g., Xeon G4). This setup highlights the inclusion of a next-generation AI CPU in 1U-NODE3 (with AI CPU (e.g., Xeon6)), which offers advanced AI processing features, such as support for AMX tiles, enabling higher throughput and reduced latency for AI workloads.

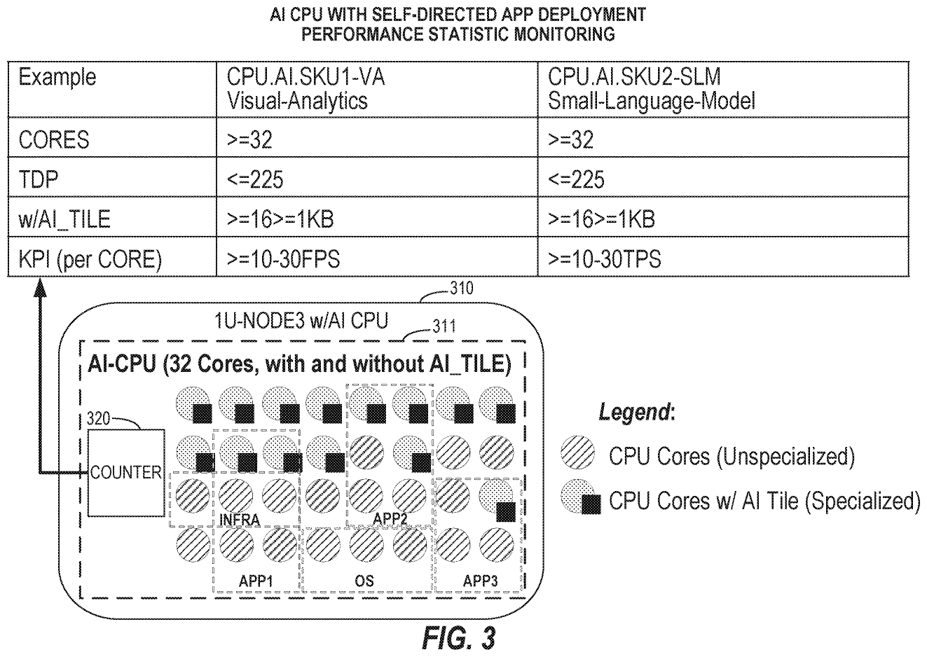

FIG. 3 illustrates a configuration table and example CPU core mapping, providing AI CPU specifications and application assignments for different types of CPU models (SKUs). The configuration table compares two example AI-CPU configurations: CPU. AI. SKU1-VA used for visual analytic processing, and CPU. AI. SKU2-SLM used for small language models. The configuration table outlines properties including cores, thermal design power (TDP), the number of AI tiles, and key performance indicators (KPIs) per core.

In FIG. 3, a node 1U-NODE3 with AI CPU 310 includes an AI-CPU 311 with an associated counter 320. Similar to the configuration of AI-CPU 111 in FIGS. 1A and 1B, the AI-CPU 311 is depicted as containing 32 cores. It will be understood that more or fewer cores may exist in various implementations. As indicated by the legend, the AI-CPU 311 includes two types of cores: CPU Cores (Unspecialized), which are general-purpose processing cores provided without an AI tile, and CPU Cores with AI Tile (Specialized), which are processing cores each provided with an integrated AI computation unit (each, an “AI Tile”). In an example, the AI tile provides hardware-accelerated matrix multiplication operations (e.g., AMX extensions) used in AI inference workloads, such as tensor operations. The specialized cores with AI tiles are distributed in a non-uniform pattern across the die of the AI-CPU 311. Not all cores will include an AI tile; in some examples, only a subset of the total cores, potentially as few as 25% or fewer, are equipped with functional AI tiles operating at a higher deterministic frequency than the base core frequency.

The 32 cores of the AI-CPU 311 are shown allocated among multiple functional partitions for applications (e.g., INFRA, OS, and APP1, APP2, and APP3). In some examples, these partitions are provided for distinct application workloads executing concurrently on the processor in a multi-tenant configuration. Each partition occupies a group of cores, with some partitions allocated to cores that potentially include AI tiles and other partitions allocated to cores that do not include AI tiles. Thus, an application workload performing AI inference using a visual analytics model or a small language model may be associated with one partition and allocated to a set of cores that includes one or more specialized cores, while an application workload that does not perform AI inference may be associated with a different partition and allocated to unspecialized cores only.

The counter 320 is a memory and/or circuit configured to collect data and performance monitoring values. In some examples, the counter 320 monitors CPU instruction-level telemetry in real time, such as some value of AI-specific mnemonics being executed, such as tensor operations or matrix multiplication instructions associated with the AI tile hardware. Performance monitoring tools may be used to collect metrics such as core utilization, uncore utilization, memory controller activity, and derivatives of these metrics, such as a percentage of workload execution time spent on AI tile operations.

The data collected by the counter 320 is used to determine whether a running workload's AI mnemonic usage exceeds a threshold, which in turn triggers dynamic reassignment of the workload's container pod from unspecialized cores to specialized cores, or from specialized cores to a different set of specialized cores with higher AI tile frequency capabilities. This monitoring is performed continuously during runtime as part of the feedback loop described in process 120B of FIG. 1B. As an example, the AI mnemonic usage may be determined as a percentage or measurement of a workload's total executed CPU instructions that involve AI-specific instruction mnemonics (e.g., AMX_TILE instructions). The AI mnemonic usage may be collected in real time by the hardware counter and expressed (or measured) as a percentage of total executed instructions.

Returning to the configuration table depicted in FIG. 3, the KPI (per core) parameter specifies that the first SKU (CPU. AI. SKU1-VA) targets greater than or equal to 10 to 30 inference frames per second (FPS) per core, while the second SKU (CPU. AI. SKU2-SLM) targets greater than or equal to 10 to 30 tokens per second (TPS) per core. These two KPI measurements represent the two types of AI inference performance that the AI-CPU 311 can be configured to deliver: frames per second for visual analytics workloads that process image or video data, and tokens per second for small language model workloads that process text-based inference. Thus, the same processor architecture of AI-CPU 311, with its mix of specialized and unspecialized cores, can serve different AI inference use cases by varying the application workload and responding to an associated performance metric.

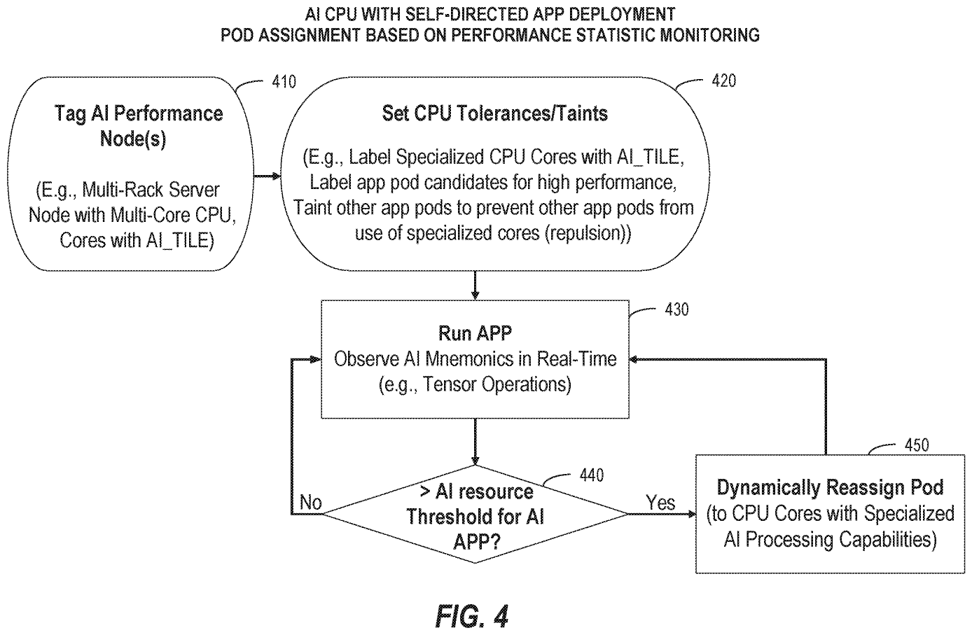

FIG. 4 illustrates a flowchart of an application deployment technique for a CPU with self-directed reassignment based on real-time AI resource utilization. The flowchart outlines a sequence of operations that ensure efficient utilization of hardware resources in edge computing environments with mixed-generation and mixed-capability CPUs.

The process begins at operation 410 with tagging high-performance nodes within a multi-rack and multi-node server environment. This tagging may be performed in connection with metadata and information to be maintained in a configuration (e.g., established during onboarding, setup, or during node discovery). For example, a node equipped with a Xeon® Generation 4 CPU or Generation 6 CPU featuring Advanced Matrix Extensions (AMX) is identified and tagged as an AI performance node. This tagging operation ensures that nodes with specialized AI acceleration capabilities in CPUs are prioritized for AI-specific tasks.

At operation 420, tolerances and taints are configured to manage the deployment of application pods. CPU processing units with AI dies, tiles, or other hardware blocks (e.g., AMX tiles) are labeled to indicate their suitability for high-performance AI tasks. Application pods requiring high performance are labeled as candidates for these processing units, while other pods are tainted to prevent them from being deployed on these high-performance processing units. This establishes a repulsion mechanism to ensure that non-AI workloads do not occupy resources optimized for AI inferencing. Not all non-AI workloads will need to be repulsed. In some scenarios, it may be beneficial to have related non-AI workloads co-exist with AI workloads, such as in scenarios where AI results are “painted” or encoded on an output graphical user interface.

At operation 430, AI applications are executed after the nodes and processing units are configured. During execution, the system monitors and captures real-time AI-specific mnemonics processing percentages, such as tensor operations. This data provides insights into the utilization of AI-specific hardware features and helps identify whether the current resource allocation is suitable.

At operation 440, an evaluation is performed to determine whether the AI resource usage for the application exceeds a predefined threshold. If the threshold is not exceeded, the process returns back to continue monitoring the live application's execution. This iterative evaluation ensures that resources are dynamically adjusted based on real-time performance metrics.

At operation 450, if the AI resource threshold is exceeded, the system dynamically reassigns the application pod to CPU units with higher AI processing capabilities. This reassignment leverages the tagged nodes and the labeled processing units to optimize performance, ensuring that AI workloads are executed on hardware with native AI acceleration features, such as AMX tiles or dies.

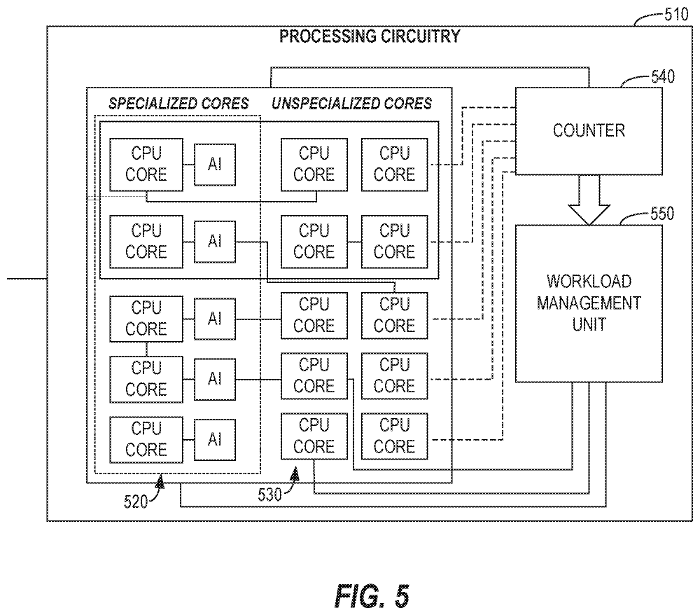

FIG. 5 illustrates an example configuration of a processing device adapted for tracking performance conditions from execution of respective processing workloads among CPU cores. This configuration depicts processing circuitry 510 that includes multiple central processing unit (CPU) cores organized into two groups: a first set of specialized cores 520 and a second set of unspecialized cores 530. A counter 540 (e.g., implemented as a memory and/or circuit) is coupled to both groups of cores and is configured to track performance condition data. A workload management unit 550 executes functions on the processing circuitry 510 and allocates processing workloads among the specialized cores 520 and the unspecialized cores 530 based on AI capabilities and performance indicators (including AI execution mnemonics tracked in the counter 540).

The specialized cores 520 include multiple CPU cores, each provided with a corresponding artificial intelligence (AI) computation unit, as similarly depicted in FIGS. 1A, 1B, and 3. In an example, the AI computation unit within each specialized core provides a matrix multiplication function implemented by a hardware block in the respective core, and the matrix multiplication function is implemented using an instruction set executed by the specialized cores 520. For instance, the AI computation unit may be a specialized die-or tile-based accelerator that performs matrix operations on data blocks of a defined size, such as 1024-byte matrix multiply-accumulate operations. Other types of specialized operations and instructions may be performed by the AI computation units such as convolution processing, data fusion, attention building blocks, reductions and pooling, and the like.

The specialized cores 520 are distributed throughout the respective compute dies or tiles of at least one compute die or tile provided by the processing circuitry 510. Not all cores in the processing circuitry 510 are equipped with the AI computation unit; thus, the specialized cores 520 represent a subset of the total CPU cores. A functional AI computation unit may be determined during manufacturing based on factors such as die-level testing, and thus may be distributed in a non-uniform pattern across the die.

The unspecialized cores 530 comprise multiple standard CPU cores, each provided without a corresponding AI computation unit. The unspecialized cores 530 provide general-purpose processing capabilities and may be capable of executing AI workloads at lower speeds or throughputs. The unspecialized cores 530 are also distributed throughout respective compute dies or tiles of the at least one compute die or tile of the processing circuitry 510.

The counter 540 comprises circuitry (e.g., a buffer or other functional unit) that tracks performance conditions, such as a measurement from the execution of respective processing workloads among the CPU cores. The performance conditions tracked by the counter 540 may include CPU instruction-level telemetry collected in real time, such as the percentage of AI-specific mnemonics being executed by a given workload, including tensor operations or matrix multiplication instructions associated with the AI computation units of the specialized cores 520. The counter 540 may also track metrics including core utilization, uncore utilization, or the like. In other examples, the performance conditions tracked by the counter 540 may directly or indirectly relate to key performance indicator (KPI) measurements, such as inference frames per second for visual analytics workloads or tokens per second for small language model workloads.

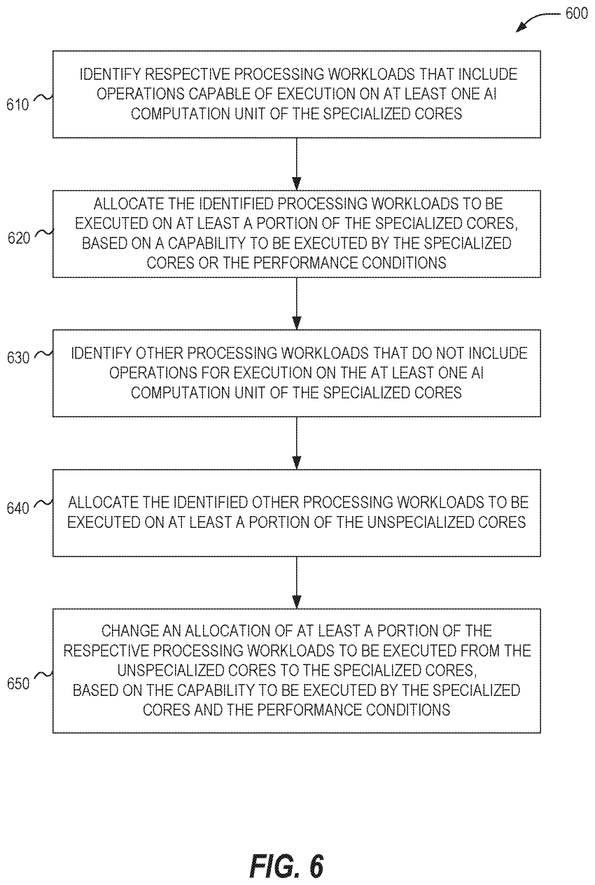

The workload management unit 550 is shown as a separate functional unit (e.g., specialized circuitry) but may execute as functionality via software instructions on one or multiple cores (e.g., as part of executed infrastructure software functions). The workload management unit 550 is configured to identify and allocate respective processing workloads among the specialized cores 520 and unspecialized cores 530, such as using the method 600 depicted in FIG. 6 and discussed below. Further, the workload management unit 550 may change an allocation of some or all of the respective processing workloads to be executed (e.g., from the unspecialized cores 530 to the specialized cores 520 and vice versa), based on the capability to be executed by the specialized cores 520 and/or the performance conditions, in accordance with the method 600 depicted in FIG. 6 and discussed below.

FIG. 6 illustrates a flowchart of an example method 600 for allocating processing workloads among CPU cores of a processing device, as discussed above. This method may operate on a processing device such as an implementation of the processing circuitry 510 discussed above, which includes at least one compute die or tile providing multiple central processing unit (CPU) cores located among a single or multiple dies. As noted above, such CPU cores can include a first set of specialized cores (e.g., cores 520), where a respective core of the specialized cores is provided with a corresponding AI computation unit (e.g., AMX tile, die, or other AI-relevant accelerator), and a second set of unspecialized cores (e.g., cores 530), where a respective core of the second set of unspecialized cores is provided without a corresponding AI computation unit.

At operation 610, the method includes identifying respective processing workloads that include operations capable of execution on at least one AI computation unit of the first set of (specialized) cores. This may include evaluating the processing workloads that are candidates for execution on the CPU cores and determining which of these workloads include operations that can be performed by the AI computation unit provided by the first set of (specialized) cores. Such operations include but are not limited to tensor operations, matrix multiplication instructions, and other AI-specific mnemonics that are executable by the hardware block within the AI computation unit.

In some examples, operation 610 may include monitoring CPU instruction-level telemetry in real time, such as measuring a percentage of AI-specific mnemonics being executed by a given workload. In other examples, operation 610 may include identifying that a particular container pod provides an application that contains or provides a pre-trained AI inference model that executes tensor operations. For instance, pods that include AI operations may be provided in a multi-tenant deployment where the respective processing workloads are provided for execution on behalf of respective tenants (e.g., different tenants from a plurality of tenants), and the workloads are separately executed for the respective tenants using container pods managed by a container orchestration framework.

At operation 620, the method includes allocating the identified processing workloads to be executed on at least a portion of the first set of (specialized) cores (e.g., cores operably coupled to AI computation units), based on a capability to be executed by the first set of (specialized) cores or the performance (e.g., performance conditions). In some examples, the performance conditions are tracked via circuitry comprising at least one counter (e.g., counter 540 discussed above). The allocating may include assigning the processing workloads (identified at operation 610) to a set of the first set of (specialized) cores that includes one or more cores equipped with AI computation units. In other examples, the allocating may be based on the capability of the first set of (specialized) cores to execute the identified workloads, which depends on whether the AI computation unit within the first set of (specialized) cores can perform the operations included in the workload, and on the performance conditions tracked in the processing circuitry (e.g., by the counter).

In a specific example, the AI computation unit within each specialized core comprises a matrix multiplication function provided by a hardware block in a respective core, and the matrix multiplication function is implemented using an instruction set executed by the first set of specialized cores. In some examples, the first set of specialized cores and the second set of unspecialized cores are distributed throughout respective compute dies or tiles of the at least one compute tile, and the at least one compute die or tile is provided by multiple compute dies or tiles arranged in a processor package. In some examples, the at least one compute die or tile is provided by multiple compute dies or tiles located in at least one processor package, and execution of the respective processing workloads among the multiple compute dies or tiles located among the at least one processor package is coordinated as a singular or discrete compute node.

At operation 630, the method includes identifying other processing workloads that do not include operations for execution on the at least one AI computation unit of the first set of specialized cores. For example, this operation may include evaluating the remaining processing workloads and determining which workloads provide general-purpose operations (that do not require, would not benefit from, or would be unable to be executed on the AI computation unit). Such workloads may include operating system tasks, infrastructure processes, applications, or other software processes that do not execute inference, tensor, or mathematical manipulation operations. In the context of a multi-tenant deployment, operation 630 may include identifying that certain container pods within an application that handle tasks such as encoding, decoding, or user interface rendering do not invoke tensor operations or matrix multiplication instructions.

At operation 640, the method includes allocating the identified other processing workloads to be executed on at least a portion of the second set of unspecialized cores. This may include assigning the processing workloads (identified at operation 630) to the second set of unspecialized cores that do not include AI computation units. By directing workloads that do not require AI processing to the second set of unspecialized cores, the first set of specialized cores may be reserved or freed up for workloads that involve AI processing. In the context of a container orchestration framework, this may include implementing a taint and toleration mechanism (e.g., described in connection with FIG. 4) where pods that do not require AI tile capabilities are excluded from being scheduled on the first set of specialized cores through a repulsion policy.

At operation 650, the method includes changing an allocation of at least a portion of the respective processing workloads to be executed from the second set of unspecialized cores to the first set of specialized cores, based on the capability of the workloads to be executed by the first set of specialized cores and/or the performance conditions. For example, this operation may include reassigning a processing workload (or a portion of the processing workload) that was previously allocated to the second set of unspecialized core(s) to instead execute on the first set of specialized core(s). This change or reassignment may be based on the capability of the first set of specialized cores to execute the workload and/or the performance conditions tracked by the counter (or other monitoring components).

In some examples, the allocation of the respective processing workloads is changed during runtime of the respective processing workloads based on evaluation of at least one of the performance conditions, such as an evaluation of a key performance indicator (KPI) measurement relative to a threshold value. For example, the reallocation may occur when a workload management function detects, from data stored in a counter during runtime, that a processing workload executing on the second set of unspecialized cores includes a percentage of AI-specific mnemonic activity that exceeds a threshold. The allocation may also be changed when an inference frames per second KPI measurement falls below a target service level, or a tensor operation utilization percentage exceeds a predefined level. The reallocation also may include reassigning a workload's container pod from the second set of unspecialized cores to the first set of specialized cores equipped with AI computation units. The reallocation may occur during a repeated sequence of running the application, tracking performance conditions, and changing the allocation as a continuous feedback loop during runtime.

In some examples, other portion(s) of respective processing workloads may be reallocated from the first set of specialized cores to the second set of unspecialized cores, based on the capability of the cores to execute the workloads and/or the performance conditions. This may involve moving workloads in either direction (between the first set of specialized cores and the second set of unspecialized cores) as conditions change during runtime, such as when a workload's AI mnemonic usage decreases and the first set of specialized cores can be freed for other workloads to utilize the AI computation unit.

In some examples, the compute node on which the method operates is deployed in a computer system having a plurality of compute nodes, and the method further comprises identifying the at least one compute die or tile having the first set of specialized cores from among the plurality of compute nodes. This enables the method to direct AI inference workloads to compute node(s) that provide processors and processor cores with AI computation units, even in heterogeneous deployments where different nodes provide systems with different CPU generations, different AI-CPU types, different node form factors, or different cluster sizes, as discussed above for FIG. 2.

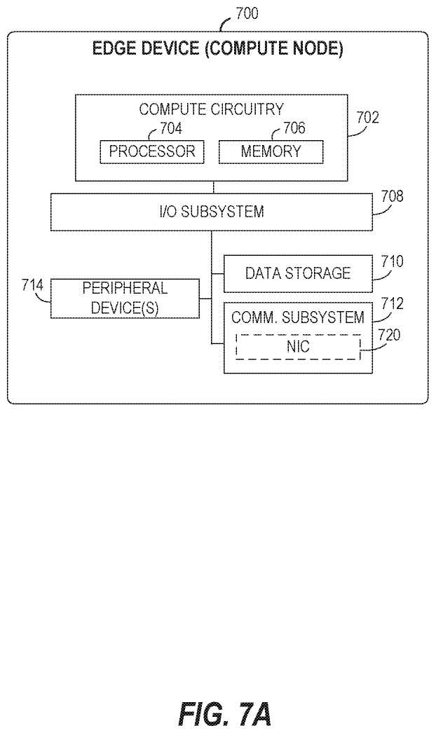

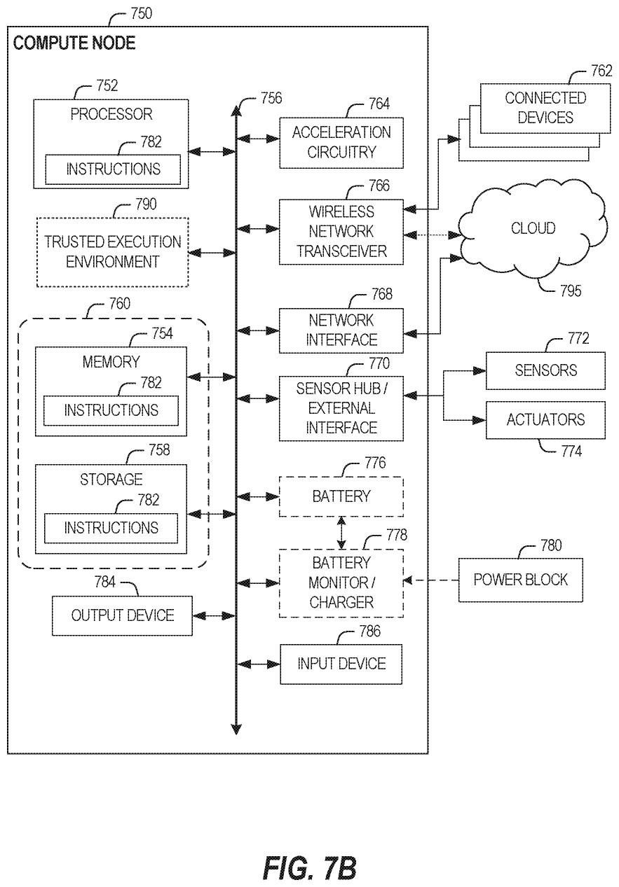

Any of the computing nodes or devices used to implement the aforementioned techniques may be implemented based on the components of an edge compute node as depicted in FIGS. 7A and 7B. Respective edge compute nodes may be embodied as a type of device, appliance, computer, or other “thing” capable of communicating with other edge, networking, or endpoint components. For example, an edge compute device may be embodied as a robot, a robot control system, a personal computer, a server, a mobile computing device, a smart appliance, an in-vehicle compute system (e.g., a navigation system), a self-contained device having an outer case, shell, etc., or other device or system capable of performing the described functions.

In the simplified example depicted in FIG. 7A, an edge compute node 700 includes a compute engine (also referred to herein as “compute circuitry”) 702, an input/output (I/O) subsystem 708, a data storage device 710, a communication circuitry 712 subsystem, and, optionally, one or more peripheral devices 714. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 700 may be embodied as any type of engine, device, or collection of devices capable of performing various compute functions. In some examples, the compute node 700 may be embodied as a single device such as an integrated circuit, an embedded system, a field-programmable gate array (FPGA), a system-on-a-chip (SOC), or other integrated system or device. In the illustrative example, the compute node 700 includes or is embodied as a processor 704 and a memory 706. The processor 704 may be embodied as any type of processor capable of performing the functions described herein (e.g., executing an application). For example, the processor 704 may be embodied as a multi-core processor(s), a microcontroller, a processing unit, a specialized or special-purpose processing unit, or other processor or processing/controlling circuit.

In some examples, the processor 704 may be embodied as, include, or be coupled to an FPGA, an application-specific integrated circuit (ASIC), reconfigurable hardware or hardware circuitry, or other specialized hardware to facilitate performance of the functions described herein. Also in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general-purpose processing hardware. However, it will be understood that an xPU, a SOC, a CPU, and other variations of the processor 704 may work in coordination with each other to execute many types of operations and instructions within and on behalf of the compute node 700.

The memory 706 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three-dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross-point architecture in which memory cells sit at the intersection of word lines and bit lines and are individually addressable and in which bit storage is based on a change in bulk resistance. In some examples, all or a portion of the memory 706 may be integrated into the processor 704. The memory 706 may store various software and data used during operation, such as one or more applications, data operated on by the application(s), libraries, and drivers.

The compute circuitry 702 is communicatively coupled to other components of the compute node 700 via the I/O subsystem 708, which may be embodied as circuitry and/or components to facilitate input/output operations with the compute circuitry 702 (e.g., with the processor 704 or the main memory 706) and other components of the compute circuitry 702. For example, the I/O subsystem 708 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 708 may form a portion of a system-on-a-chip (SoC) and be incorporated, along with one or more of the processor 704, the memory 706, and other components of the compute circuitry 702, into the compute circuitry 702.

The one or more illustrative data storage devices 710 may be embodied as any type of devices configured for short-term or long-term storage of data, such as, for example, memory devices and circuits, memory cards, hard disk drives, solid-state drives, or other data storage devices. Individual data storage devices 710 may include a system partition that stores data and firmware code for the data storage device 710. Individual data storage devices 710 may also include one or more operating system partitions that store data files and executables for operating systems, depending on, for example, the type of compute node 700.

The communication circuitry 712 may be embodied as any communication circuit, device, or collection thereof, capable of enabling communications over a network between the compute circuitry 702 and another compute device (e.g., a gateway of an implementing computing system). The communication circuitry 712 may be configured to use one or more communication technologies (e.g., wired or wireless communications) and associated protocols (e.g., a cellular networking protocol such as a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 712 includes a network interface controller (NIC) 720, which may also be referred to as a host fabric interface (HFI). The NIC 720 may be embodied as one or more add-in-boards, daughter cards, network interface cards, controller chips, chipsets, or other devices that may be used by the compute node 700 to connect with another compute device (e.g., a gateway node). In some examples, the NIC 720 may be embodied as part of a system-on-a-chip (SoC) that includes one or more processors, or included on a multichip package that also contains one or more processors. In some examples, the NIC 720 may include a local processor (not shown) and/or a local memory (not shown) that are both local to the NIC 720. In such examples, the local processor of the NIC 720 may be capable of performing one or more of the functions of the compute circuitry 702 described herein. Additionally, or alternatively, in such examples, the local memory of the NIC 720 may be integrated into one or more components of the client compute node at the board level, socket level, chip level, or other levels.

Additionally, in some examples, a respective compute node 700 may include one or more peripheral devices 714. Such peripheral devices 714 may include any type of peripheral device found in a compute device or server, such as audio input devices, a display, other input/output devices, interface devices, and/or other peripheral devices, depending on the particular type of the compute node 700. In further examples, the compute node 700 may be embodied by a respective compute node (whether a client, gateway, or aggregation node) in a computing system or like forms of appliances, computers, subsystems, circuitry, or other components.

In a more detailed example, FIG. 7B illustrates a block diagram of an example of components that may be present in a computing node 750 for implementing the techniques (e.g., operations, processes, methods, and methodologies) described herein. This computing node 750 provides a closer view of the respective components of node 700 when implemented as or as part of a computing device (e.g., as a mobile device, a base station, server, gateway, etc.). The computing node 750 may include any combinations of the hardware or logical components referenced herein, and it may include or couple with any device usable with a communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the computing node 750, or as components otherwise incorporated within a chassis of a larger system.

The computing node 750 may include processing circuitry in the form of a processor 752, which may be a microprocessor, a multi-core processor, a multithreaded processor, an ultra-low voltage processor, an embedded processor, an xPU/DPU/IPU/NPU, special-purpose processing unit, specialized processing unit, or other known processing elements. The processor 752 may be a part of a system on a chip (SoC) in which the processor 752 and other components are formed into a single integrated circuit, or a single package, such as the Edison™ or Galileo™ SoC boards from Intel Corporation, Santa Clara, California. As an example, the processor 752 may include an Intel® Architecture Core™ based CPU processor, such as a Quark™, an Atom™, an i3, an i5, an i7, an i9, or an MCU-class processor, or another such processor available from Intel®. However, any number of other processors may be used, such as those available from Advanced Micro Devices, Inc. (AMD®) of Sunnyvale, California, a MIPS®-based design from MIPS Technologies, Inc. of Sunnyvale, California, an ARM®-based design licensed from ARM Holdings, Ltd., or a customer thereof, or their licensees or adopters. The processors may include units such as an A5-A19 processor from Apple® Inc., a Snapdragon™ processor from Qualcomm® Technologies, Inc., or an OMAP™ processor from Texas Instruments, Inc. The processor 752 and accompanying circuitry may be provided in a single socket form factor, multiple socket form factor, or a variety of other formats, including in limited hardware configurations or configurations that include fewer than all elements shown in FIG. 7B.

The processor 752 may communicate with a system memory 754 over an interconnect 756 (e.g., a bus). Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types, such as single die package (SDP), dual die package (DDP), or quad die package (QDP). These devices, in some examples, may be directly soldered onto a motherboard to provide a lower profile solution, while in other examples, the devices are configured as one or more memory modules that in turn couple to the motherboard by a given connector. Any number of other memory implementations may be used, such as other types of memory modules, e.g., dual inline memory modules (DIMMs) of different varieties, including but not limited to microDIMMs or MiniDIMMs.

To provide for persistent storage of information, such as data, applications, operating systems, and so forth, a storage 758 may also be coupled to the processor 752 via the interconnect 756. In an example, the storage 758 may be implemented via a solid-state disk drive (SSD). Other devices that may be used for the storage 758 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory-based device, a magnetic tunneling junction (MTJ) based device, a DW (Domain Wall) and SOT (Spin Orbit Transfer)-based device, a thyristor-based memory device, or a combination of any of the above, or other memory.

In low-power implementations, the storage 758 may be on-die memory or registers associated with the processor 752. However, in some examples, the storage 758 may be implemented using a micro hard disk drive (HDD). Further, any number of new technologies may be used for the storage 758 in addition to, or instead of, the technologies described, such as resistance change memories, phase change memories, holographic memories, or chemical memories, among others.

The components may communicate over the interconnect 756. The interconnect 756 may include any number of technologies, including industry standard architecture (ISA), extended ISA (EISA), peripheral component interconnect (PCI), peripheral component interconnect extended (PCIx), PCI Express (PCIe), or any number of other technologies. The interconnect 756 may be a proprietary bus, for example, used in an SoC-based system. Other bus systems may be included, such as an Inter-Integrated Circuit (I2C) interface, a Serial Peripheral Interface (SPI) interface, point-to-point interfaces, and a power bus, among others.

The interconnect 756 may couple the processor 752 to a transceiver 766, for communications with the connected devices 762. The transceiver 766 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected devices 762. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 766 (or multiple transceivers) may communicate using multiple standards or radios for communications at different ranges. For example, the computing node 750 may communicate with close devices, e.g., within about 7 meters, using a local transceiver based on Bluetooth Low Energy (BLE), or another low-power radio, to save power. More distant connected devices 762, e.g., within about 50 meters, may be reached over ZigBee® or other intermediate-power radios. Both communications techniques may take place over a single radio at different power levels or may take place over separate transceivers, for example, a local transceiver using BLE and a separate mesh transceiver using ZigBee®.

A wireless network transceiver 766 (e.g., a radio transceiver) may be included to communicate with devices or services in the cloud 795 via local or wide area network protocols. The wireless network transceiver 766 may be a low-power wide-area (LPWA) transceiver that follows the IEEE 802.15.4, or IEEE 802.15.4g standards, among others. The computing node 750 may communicate over a wide area using LoRaWAN™ (Long Range Wide Area Network) developed by Semtech and the LoRa Alliance. The techniques described herein are not limited to these technologies but may be used with any number of other cloud transceivers that implement long-range, low-bandwidth communications, such as Sigfox, and other technologies. Further, other communications techniques, such as time-slotted channel hopping, described in the IEEE 802.15.4e specification, may be used.

Any number of other radio communications and protocols may be used in addition to the systems mentioned for the wireless network transceiver 766, as described herein. For example, the transceiver 766 may include a cellular transceiver that uses spread spectrum (SPA/SAS) communications for implementing high-speed communications. Further, any number of other protocols may be used, such as Wi-Fi® networks for medium-speed communications and provision of network communications. The transceiver 766 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 768 may be included to provide a wired communication to nodes of the cloud 795 or to other devices, such as the connected devices 762 (e.g., operating in a mesh). The wired communication may provide an Ethernet connection or may be based on other types of networks, such as Controller Area Network (CAN), Local Interconnect Network (LIN), DeviceNet, ControlNet, Data Highway⁺, PROFIBUS, or PROFINET, among many others. An additional NIC 768 may be included to enable connecting to a second network, for example, a first NIC 768 providing communications to the cloud over Ethernet, and a second NIC 768 providing communications to other devices over another type of network.

Given the variety of types of applicable communications from the device to another component or network, applicable communications circuitry used by the device may include or be embodied by any one or more of components (circuitry 764, transceiver 766, NIC 768, or interface 770). Accordingly, in various examples, applicable means for communicating (e.g., receiving, transmitting, etc.) may be embodied by such communications circuitry.

The computing node 750 may include or be coupled to acceleration circuitry 764, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific computing tasks for service management and service operations discussed elsewhere in this document.

The interconnect 756 may couple the processor 752 to a sensor hub or external interface 770 that is used to connect additional devices or subsystems. The devices may include sensors 772, such as accelerometers, level sensors, flow sensors, optical light sensors, camera sensors, temperature sensors, global navigation system (e.g., GPS) sensors, pressure sensors, barometric pressure sensors, and the like. The hub or interface 770 further may be used to connect the computing node 750 to actuators 774, such as power switches, valve actuators, an audible sound generator, a visual warning device, and the like.

In some optional examples, various input/output (I/O) devices may be present within or connected to the computing node 750. For example, a display or other output device 784 may be included to show information, such as sensor readings or actuator position. An input device 786, such as a touch screen or keypad, may be included to accept input. An output device 784 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the computing node 750. A display or console hardware, in the context of the present system, may be used to provide output and receive input of a computing system; to manage components or services of a computing system; identify a state of a computing component or service; or to conduct any other number of management or administration functions or service use cases.

A battery 776 may power the computing node 750, although, in examples in which the computing node 750 is mounted in a fixed location, it may have a power supply coupled to an electrical grid, or the battery may be used as a backup or for temporary capabilities. The battery 776 may be a lithium-ion battery, or a metal-air battery, such as a zinc-air battery, an aluminum-air battery, a lithium-air battery, and the like.

A battery monitor/charger 778 may be included in the computing node 750 to track the state of charge (SoCh) of the battery 776, if included. The battery monitor/charger 778 may be used to monitor other parameters of the battery 776 to provide failure predictions, such as the state of health (SoH) and the state of function (SoF) of the battery 776. The battery monitor/charger 778 may include a battery monitoring integrated circuit, such as an LTC 4020 or an LTC2990 from Linear Technologies, an ADT7488A from ON Semiconductor of Phoenix, Arizona, or an IC from the UCD90xxx family from Texas Instruments of Dallas, Texas. The battery monitor/charger 778 may communicate the information on the battery 776 to the processor 752 over the interconnect 756. The battery monitor/charger 778 may also include an analog-to-digital (ADC) converter that enables the processor 752 to directly monitor the voltage of the battery 776 or the current flow from the battery 776. The battery parameters may be used to determine actions that the computing node 750 may perform, such as transmission frequency, mesh network operation, sensing frequency, and the like.

A power block 780, or other power supply coupled to a grid, may be coupled with the battery monitor/charger 778 to charge the battery 776. In some examples, the power block 780 may be replaced with a wireless power receiver to obtain the power wirelessly, for example, through a loop antenna in the computing node 750. A wireless battery charging circuit, such as an LTC4020 chip from Linear Technologies of Milpitas, California, among others, may be included in the battery monitor/charger 778. The specific charging circuits may be selected based on the size of the battery 776, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 758 may include instructions 782 in the form of software, firmware, or hardware commands to implement the techniques described herein. Although such instructions 782 are shown as code blocks included in the memory 754 and the storage 758, it may be understood that any of the code blocks may be replaced with hardwired circuits, for example, built into an application-specific integrated circuit (ASIC).

In an example, the instructions 782 provided via the memory 754, the storage 758, or the processor 752 may be embodied as a non-transitory, machine-readable medium 760 (also referred to as a device-readable medium or storage medium) including code to direct the processor 752 to perform electronic operations in the computing node 750. The processor 752 may access the non-transitory, machine-readable medium 760 over the interconnect 756. For instance, the non-transitory, machine-readable medium 760 may be embodied by devices described for the storage 758 or may include specific storage units such as optical disks, flash drives, or any number of other hardware devices. The non-transitory, machine-readable medium 760 may include instructions to direct the processor 752 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 782 on the processor 752 (separately, or in combination with the instructions 782 of the machine-readable medium 760) may configure execution or operation of a trusted execution environment (TEE) 790. In an example, the TEE 790 operates as a protected area accessible to the processor 752 for secure execution of instructions and secure access to data. Various implementations of the TEE 790, and an accompanying secure area in the processor 752 or the memory 754 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the computing node 750 through the TEE 790 and the processor 752.

In further examples, a machine-readable medium also includes any tangible medium that is capable of storing, encoding, or carrying instructions for execution by a machine and that causes the machine to perform any one or more of the methodologies of the present disclosure or that is capable of storing, encoding, or carrying data structures utilized by or associated with such instructions. A “machine-readable medium” thus may include, but is not limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus that is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

It should be understood that the functional units or capabilities described in this specification may have been referred to or labeled as components or modules, in order to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field-programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together but may comprise disparate instructions stored in different locations that, when joined logically together (e.g., including over a wire, over a network, using one or more platforms, wirelessly, via a software component, or the like), comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center) than that in which the code is deployed (e.g., in a computer embedded in a sensor or robot). Similarly, operational data may be identified and illustrated herein within components or modules and may be embodied in any suitable form and organized within any suitable type of data structure. The operational data may be collected as a single data set or may be distributed over different locations, including over different storage devices, and may exist, at least partially, merely as electronic signals on a system or network. The components or modules may be passive or active, including agents operable to perform desired functions.

Additional examples of the presently described method, system, and device embodiments include the following non-limiting implementations provided in the claims and/or drawings. Each of the following non-limiting examples may stand on its own or may be combined in any permutation or combination with any one or more of the other examples provided below or throughout the present disclosure.

Example 1 is a processing device, comprising: circuitry comprising at least one compute die providing multiple central processing unit (CPU) cores, the CPU cores including: a first set of cores, wherein a respective core of the first set of cores is provided with a corresponding artificial intelligence (AI) computation unit; and a second set of cores, wherein a respective core of the second set of cores is provided without a corresponding AI computation unit; and circuitry comprising at least one counter to track performance (e.g., performance conditions) from execution of respective processing workloads among the CPU cores; wherein the processing device is configured to: identify the respective processing workloads that include operations capable of execution on at least one AI computation unit of the first set of cores; and allocate the identified processing workloads to be executed on at least a portion of the first set of cores, based on a capability to be executed by the first set of cores or meet performance conditions.

In Example 2, the subject matter of Example 1 optionally includes wherein the processing device is further configured to: identify other processing workloads that do not include operations for execution on the at least one AI computation unit of the first set of cores; and allocate the identified other processing workloads to be executed on at least a portion of the second set of cores.

In Example 3, the subject matter of any one or more of Examples 1-2 optionally includes wherein the processing device is further configured to: change an allocation of at least a portion of the respective processing workloads to be executed from the second set of cores to the first set of cores, based on the capability to be executed by the first set of cores and the performance conditions.

In Example 4, the subject matter of Example 3 optionally includes wherein the allocation of the respective processing workloads is changed during runtime of the respective processing workloads based on evaluation of at least one of the performance conditions (e.g., an evaluation of a key performance indicator (KPI) measurement relative to a threshold value).

In Example 5, the subject matter of any one or more of Examples 3-4 optionally includes wherein the processing device is further configured to: change an allocation of at least another portion of the respective processing workloads to be executed from the first set of cores to the second set of cores, based on the capability to be executed by the first set of cores and the performance conditions.

In Example 6, the subject matter of any one or more of Examples 1-5 optionally includes wherein the respective processing workloads are provided for execution on behalf of respective tenants using containers (e.g., wherein the respective processing workloads are separately executed for the respective tenants using container pods managed by a container orchestration framework).

In Example 7, the subject matter of any one or more of Examples 1-6 optionally includes wherein the corresponding AI computation unit comprises a matrix multiplication function provided by a hardware block in a respective core, and wherein the matrix multiplication function is implemented using an instruction set executed by the first set of cores.

In Example 8, the subject matter of any one or more of Examples 1-7 optionally includes wherein the first set of cores and the second set of cores are distributed throughout respective compute dies of the at least one compute die, and wherein the at least one compute die is provided by multiple compute dies arranged in a processor package.

In Example 9, the subject matter of any one or more of Examples 1-8 optionally includes wherein the at least one compute die is provided by multiple compute dies located in at least one processor package, wherein execution of the respective processing workloads among the multiple compute dies located among the at least one processor package is coordinated as a compute node.

In Example 10, the subject matter of Example 9 optionally includes wherein the compute node is deployed in a computer system having a plurality of compute nodes, and wherein the processing device is further configured to identify the at least one compute die having the first set of cores from among the plurality of compute nodes in the computer system.

Example 11 is a computer system, comprising: processing circuitry, including: at least one compute die providing multiple central processing unit (CPU) cores, the CPU cores including: a first set of cores, wherein a respective core of the first set of cores is provided with a corresponding artificial intelligence (AI) computation unit; and a second set of cores, wherein a respective core of the second set of cores is provided without a corresponding AI computation unit; and at least one counter to track performance (e.g., performance conditions) from execution of respective processing workloads among the CPU cores; and at least one memory device including instructions embodied thereon, wherein the instructions, when executed by the processing circuitry, configure the processing circuitry to: identify the respective processing workloads that include operations capable of execution on at least one AI computation unit of the first set of cores; and allocate the identified processing workloads to be executed on at least a portion of the first set of cores, based on a capability to be executed by the first set of cores or meet performance conditions.

In Example 12, the subject matter of Example 11 optionally includes wherein the instructions, when executed by the processing circuitry, further configure the processing circuitry to: identify other processing workloads that do not include operations for execution on the at least one AI computation unit of the first set of cores; and allocate the identified other processing workloads to be executed on at least a portion of the second set of cores.

In Example 13, the subject matter of any one or more of Examples 11-12 optionally includes wherein the instructions, when executed by the processing circuitry, further configure the processing circuitry to: change an allocation of at least a portion of the respective processing workloads to be executed from the second set of cores to the first set of cores, based on the capability to be executed by the first set of cores and the performance conditions.

In Example 14, the subject matter of Example 13 optionally includes wherein the allocation of the respective processing workloads is changed during runtime of the respective processing workloads based on evaluation of at least one of the performance conditions (e.g., an evaluation of a key performance indicator (KPI) measurement relative to a threshold value).

In Example 15, the subject matter of any one or more of Examples 13-14 optionally includes wherein the instructions, when executed by the processing circuitry, further configure the processing circuitry to: change an allocation of at least another portion of the respective processing workloads to be executed from the first set of cores to the second set of cores, based on the capability to be executed by the first set of cores and the performance conditions.

In Example 16, the subject matter of any one or more of Examples 11-15 optionally includes wherein the respective processing workloads are provided for execution on behalf of respective tenants using containers (e.g., wherein the respective processing workloads are separately executed for the respective tenants using container pods managed by a container orchestration framework).

In Example 17, the subject matter of any one or more of Examples 11-16 optionally includes wherein the corresponding AI computation unit comprises a matrix multiplication function provided by a hardware block in a respective core, and wherein the matrix multiplication function is implemented using an instruction set executed by the first set of cores.

In Example 18, the subject matter of any one or more of Examples 11-17 optionally includes wherein the first set of cores and the second set of cores are distributed throughout respective compute dies of the at least one compute die, and wherein the at least one compute die is provided by multiple compute dies arranged in a processor package.

In Example 19, the subject matter of any one or more of Examples 11-18 optionally includes wherein the at least one compute die is provided by multiple compute dies located in at least one processor package, wherein execution of the respective processing workloads among the multiple compute dies located among the at least one processor package is coordinated as a compute node.

In Example 20, the subject matter of Example 19 optionally includes wherein the compute node is deployed in a system having a plurality of compute nodes, and wherein the processing circuitry is further configured to identify the at least one compute die having the first set of cores from among the plurality of compute nodes in the computer system.

Example 21 is a computer-implemented method for allocating processing workloads among CPU cores, the method comprising: accessing, via circuitry comprising at least one compute die, multiple central processing unit (CPU) cores, the CPU cores including a first set of cores, wherein a respective core of the first set of cores is provided with a corresponding artificial intelligence (AI) computation unit, and a second set of cores, wherein a respective core of the second set of cores is provided without a corresponding AI computation unit; tracking, via circuitry comprising at least one counter, performance (e.g., performance conditions) from execution of respective processing workloads among the CPU cores; identifying the respective processing workloads that include operations capable of execution on at least one AI computation unit of the first set of cores; and allocating the identified processing workloads to be executed on at least a portion of the first set of cores, based on a capability to be executed by the first set of cores or meet performance conditions.

In Example 22, the subject matter of Example 21 optionally includes identifying other processing workloads that do not include operations for execution on the at least one AI computation unit of the first set of cores; and allocating the identified other processing workloads to be executed on at least a portion of the second set of cores.

In Example 23, the subject matter of any one or more of Examples 21-22 optionally includes changing an allocation of at least a portion of the respective processing workloads to be executed from the second set of cores to the first set of cores, based on the capability to be executed by the first set of cores and the performance conditions.

In Example 24, the subject matter of Example 23 optionally includes wherein changing the allocation of the respective processing workloads further comprises changing the allocation during runtime of the respective processing workloads based on evaluation of at least one of the performance conditions (e.g., an evaluation of a key performance indicator (KPI) measurement relative to a threshold value).

In Example 25, the subject matter of any one or more of Examples 23-24 optionally includes changing an allocation of at least another portion of the respective processing workloads to be executed from the first set of cores to the second set of cores, based on the capability to be executed by the first set of cores and the performance conditions.

In Example 26, the subject matter of any one or more of Examples 21-25 optionally includes wherein the respective processing workloads are provided for execution on behalf of respective tenants using containers (e.g., wherein the respective processing workloads are separately executed for the respective tenants using container pods managed by a container orchestration framework).

In Example 27, the subject matter of any one or more of Examples 21-26 optionally includes wherein the corresponding AI computation unit comprises a matrix multiplication function provided by a hardware block in a respective core, and wherein the matrix multiplication function is implemented using an instruction set executed by the first set of cores.

In Example 28, the subject matter of any one or more of Examples 21-27 optionally includes wherein the first set of cores and the second set of cores are distributed throughout respective compute dies of the at least one compute die, and wherein the at least one compute die is provided by multiple compute dies arranged in a processor package.

In Example 29, the subject matter of any one or more of Examples 21-28 optionally includes wherein the at least one compute die is provided by multiple compute dies located in at least one processor package, wherein execution of the respective processing workloads among the multiple compute dies located among the at least one processor package is coordinated as a compute node.

In Example 30, the subject matter of Example 29 optionally includes identifying the at least one compute die having the first set of cores from among a plurality of compute nodes in a computer system, wherein the compute node is deployed in the computer system having the plurality of compute nodes.

Example 31 is at least one machine-readable medium (e.g., a non-transitory computer-readable storage medium) including instructions that, when executed by processing circuitry, cause the processing circuitry to perform operations to implement any of Examples 1-30. 30.

Example 32 is a method to manufacture, use, control, implement, or perform operations for any of Examples 1-30.

Example 33 is an apparatus comprising means to implement any of Examples 1-30.

Example 34 is a system to implement any of Examples 1-30.

Example 35 is a method to implement any of Examples 1-30.

Although these implementations have been described with reference to specific exemplary aspects, it will be evident that various modifications and changes may be made to these aspects without departing from the broader scope of the present disclosure. Many of the arrangements and processes described herein can be used in combination or in parallel implementations to provide greater bandwidth/throughput and to support edge services selections that can be made available to the edge systems being serviced. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

Such aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer-readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read-only memories (ROMs), and the like.

What is claimed is:

1. A processing device, comprising:
circuitry comprising at least one compute die providing multiple central processing unit (CPU) cores, the CPU cores including:
a first set of cores, wherein a respective core of the first set of cores is provided with a corresponding artificial intelligence (AI) computation unit; and
a second set of cores, wherein a respective core of the second set of cores is provided without a corresponding AI computation unit; and
circuitry to track performance from execution of respective processing workloads among the CPU cores;
wherein the processing device is configured to:
identify the respective processing workloads that include operations capable of execution on at least one AI computation unit of the first set of cores; and
allocate the identified processing workloads to be executed on at least a portion of the first set of cores, based on a capability to be executed by the first set of cores or meet performance conditions.

2. The processing device of claim 1, wherein the processing device is further configured to:
identify other processing workloads that do not include operations for execution on the at least one AI computation unit of the first set of cores; and
allocate the identified other processing workloads to be executed on at least a portion of the second set of cores.

3. The processing device of claim 1, wherein the processing device is further configured to:
change an allocation of at least a portion of the respective processing workloads to be executed from the second set of cores to the first set of cores, based on the capability to be executed by the first set of cores and the performance conditions.

4. The processing device of claim 3, wherein the allocation of the respective processing workloads is changed during runtime of the respective processing workloads based on evaluation of at least one of the performance conditions.

5. The processing device of claim 3, wherein the processing device is further configured to:
change an allocation of at least another portion of the respective processing workloads to be executed from the first set of cores to the second set of cores, based on the capability to be executed by the first set of cores and the performance conditions.

6. The processing device of claim 1, wherein the respective processing workloads are provided for execution on behalf of respective tenants using containers.

7. The processing device of claim 1, wherein the corresponding AI computation unit comprises a matrix multiplication function provided by a hardware block in a respective core, and wherein the matrix multiplication function is implemented using an instruction set executed by the first set of cores.

8. The processing device of claim 1, wherein the first set of cores and the second set of cores are distributed throughout respective compute dies of the at least one compute die, and
wherein the at least one compute die is provided by multiple compute dies arranged in a processor package.

9. The processing device of claim 1, wherein the at least one compute die is provided by multiple compute dies located in at least one processor package, wherein execution of the respective processing workloads among the multiple compute dies located among the at least one processor package is coordinated as a compute node.

10. The processing device of claim 9, wherein the compute node is deployed in a computer system having a plurality of compute nodes, and wherein the processing device is further configured to identify the at least one compute die having the first set of cores from among the plurality of compute nodes in the computer system.

11. A computer system, comprising:
processing circuitry, including:
at least one compute die providing multiple central processing unit (CPU) cores, the CPU cores including:
a first set of cores, wherein a respective core of the first set of cores is provided with a corresponding artificial intelligence (AI) computation unit; and
a second set of cores, wherein a respective core of the second set of cores is provided without a corresponding AI computation unit; and
at least one counter to track performance conditions from execution of respective processing workloads among the CPU cores; and
at least one memory device including instructions embodied thereon, wherein the instructions, when executed by the processing circuitry, configure the processing circuitry to:
identify the respective processing workloads that include operations capable of execution on at least one AI computation unit of the first set of cores; and
allocate the identified processing workloads to be executed on at least a portion of the first set of cores, based on a capability to be executed by the first set of cores or meet the performance conditions.

12. The computer system of claim 11, wherein the instructions, when executed by the processing circuitry, further configure the processing circuitry to:
identify other processing workloads that do not include operations for execution on the at least one AI computation unit of the first set of cores; and
allocate the identified other processing workloads to be executed on at least a portion of the second set of cores.

13. The computer system of claim 11, wherein the instructions, when executed by the processing circuitry, further configure the processing circuitry to:
change an allocation of at least a portion of the respective processing workloads to be executed from the second set of cores to the first set of cores, based on the capability to be executed by the first set of cores and the performance conditions.

14. The computer system of claim 13, wherein the allocation of the respective processing workloads is changed during runtime of the respective processing workloads based on evaluation of at least one of the performance conditions, including an evaluation of a key performance indicator (KPI) measurement relative to a threshold value.

15. The computer system of claim 13, wherein the instructions, when executed by the processing circuitry, further configure the processing circuitry to:
change an allocation of at least another portion of the respective processing workloads to be executed from the first set of cores to the second set of cores, based on the capability to be executed by the first set of cores and the performance conditions.

16. The computer system of claim 11, wherein the respective processing workloads are provided for execution on behalf of respective tenants using containers.

17. The computer system of claim 11, wherein the corresponding AI computation unit comprises a matrix multiplication function provided by a hardware block in a respective core, and wherein the matrix multiplication function is implemented using an instruction set executed by the first set of cores.

18. The computer system of claim 11, wherein the first set of cores and the second set of cores are distributed throughout respective compute dies of the at least one compute die, and
wherein the at least one compute die is provided by multiple compute dies arranged in a processor package.

19. The computer system of claim 11, wherein the at least one compute die is provided by multiple compute dies located in at least one processor package, wherein execution of the respective processing workloads among the multiple compute dies located among the at least one processor package is coordinated as a compute node.

20. The computer system of claim 19, wherein the compute node is deployed in a system having a plurality of compute nodes, and wherein the processing circuitry is further configured to identify the at least one compute die having the first set of cores from among the plurality of compute nodes in the computer system.
